(19) United States
(12) Patent Application Publication
(10) Pub. No.: US 2019/0199046 A1
(43) Pub. Date: Jun. 27, 2019

(54) REMOTE CONTROL TERMINAL

(71) Applicant: SZ DJI TECHNOLOGY CO., LTD., Shenzhen (CN)

(72) Inventors: Bo YUAN, Shenzhen (CN); Lei DENG, Shenzhen (CN); Zhenkai WU, Shenzhen (CN)

(21) Appl. No.: 16/293,307

(22) Filed: Mar. 5, 2019

Related U.S. Application Data
(63) Continuation of application No. PCT/CN2016/099025, filed on Sep. 14, 2016.

(51) Int. Cl. H01R 27/02; G05D 1/00; B64C 39/02; H01R 24/60; F16B 2/10

(52) U.S. Cl. CPC H01R 27/02; G05D 1/0038; F16B 2/10; H01R 24/60; B64C 39/024

(57) ABSTRACT

A remote control terminal includes a connection cable, a remote control main body, and a holding mechanism. The connection cable includes a first connection terminal, a second connection terminal, and a connection wire. The connection wire is between the first connection terminal and the second connection terminal. The remote control main body includes an electrical connection interface at a side of the remote control main body. The electrical connection interface is configured to be coupled to the first connection terminal. The holding mechanism is connected to the remote control main body and configured to move relative to the remote control main body to switch between an extended state and a contracted state. The holding mechanism includes a positioning mechanism. The positioning mechanism is configured to position the second connection terminal.

### CROSS-REFERENCE TO RELATED APPLICATION

This application is a continuation application of International Application No. PCT/CN2016/099025, filed on Sep. 14, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The disclosure relates to a technical field of connection cable routing design and, in particular, to a remote control terminal.

### BACKGROUND

Unmanned aerial vehicles (UAVs) have become popular aerial photography tools and have high operability. A user usually uses a remote controller to control a UAV to fly and connects a mobile communication terminal, such as a mobile phone, to the remote controller. Through the remote controller, the mobile communication terminal can receive and display image data acquired by the UAV and share image data with other devices.

The remote controller and the mobile terminal need to maintain a long-time online operation. Therefore, to ensure the stability of an image data transmission, a connection cable is usually used to connect the remote control with the mobile terminal. However, a currently used connection cable is usually independent from the remote control main body. When in use, the connection cable is usually scattered around the remote controller, which affects the appearance of the remote controller. The scattered connection cable can be easily damaged and is not easy to carry. When the connection cable is not in use, it is easy to lose or be left behind, resulting in poor user experience.

### SUMMARY

In accordance with the disclosure, there is provided a remote control terminal. The remote control terminal includes a connection cable, a remote control main body, and a holding mechanism. The connection cable includes a first connection terminal, a second connection terminal, and a connection wire. The connection wire is between the first connection terminal and the second connection terminal. The remote control main body includes an electrical connection interface at a side of the remote control main body. The electrical connection interface is configured to be coupled to the first connection terminal. The holding mechanism is connected to the remote control main body and configured to move relative to the remote control main body to switch between an extended state and a contracted state. The holding mechanism includes a positioning mechanism. The positioning mechanism is configured to position the second connection terminal.

### DESCRIPTION OF THE DRAWINGS

FIG. 1 is a perspective view of a remote control terminal according to an embodiment of the present disclosure, where a holding mechanism of the remote control terminal is in a contracted state.

FIG. 2 is a perspective view of the remote control terminal of FIG. 1 connected with a mobile terminal, where the holding mechanism of the remote control terminal is in an extended state.

FIG. 3 is a perspective view of a connection cable according to an embodiment of the present disclosure.

FIG. 4 is a perspective view of the remote control terminal in FIG. 2, with the connection cable separated from a remote controller body and the holding mechanism.

FIG. 5 is a perspective view of the remote control terminal of FIG. 4 from another perspective.

FIG. 6 is a partially enlarged exploded view of a positioning mechanism of the holding mechanism in FIG. 4.

FIG. 7 is a perspective view showing the connection cable and a sliding frame of the positioning mechanism in a first mating state according to an embodiment of the present disclosure.

FIG. 8 is a perspective view showing the connection cable and the sliding frame of the positioning mechanism in a second mating state according to an embodiment of the present disclosure.

FIG. 9 is a perspective view of the remote control terminal in FIG. 2 from another perspective.

FIG. 10 is another perspective view of the remote control terminal according to an embodiment of the present disclosure, where the holding mechanism of the remote control terminal is in an extended state.

FIG. 11 is a perspective view of the remote control terminal of FIG. 10 connected to a mobile terminal.

### REFERENCE NUMERALS FOR MAIN COMPONENTS

| | |
|---|---|
| Remote control terminal | 100, 100′ |
| Remote control main body | 20, 20′ |
| Electrical connection interface (also referred as first | 21 |
| connection interface) | |
| Wire tray | 22 |
| Receiving member | 23, 23′ |
| Operation device | 251 |
| Function buttons | 252 |
| Antenna | 253 |
| Holding mechanism | 30, 30′ |
| Positioning mechanism | 31, 31′ |
| Accommodating member | 311 |
| First mating structure | 3111 |
| Sliding frame | 312 |
| Through hole | 3121 |
| Second mating structure | 3122 |
| Clamping member | 32 |
| Connection cable | 40 |
| First connection terminal | 41 |
| Second connection terminal | 42 |
| Connecting member | 421 |
| Pressing member | 422 |
| Flange | 4221 |
| Connection wire | 43 |
| Connection mechanism | 50, 50′ |
| Sliding member | 51 |
| Mobile terminal | 600 |
| Mobile terminal interface (also referred as second | 61 |
| connection interface) | |

### DETAILED DESCRIPTION

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

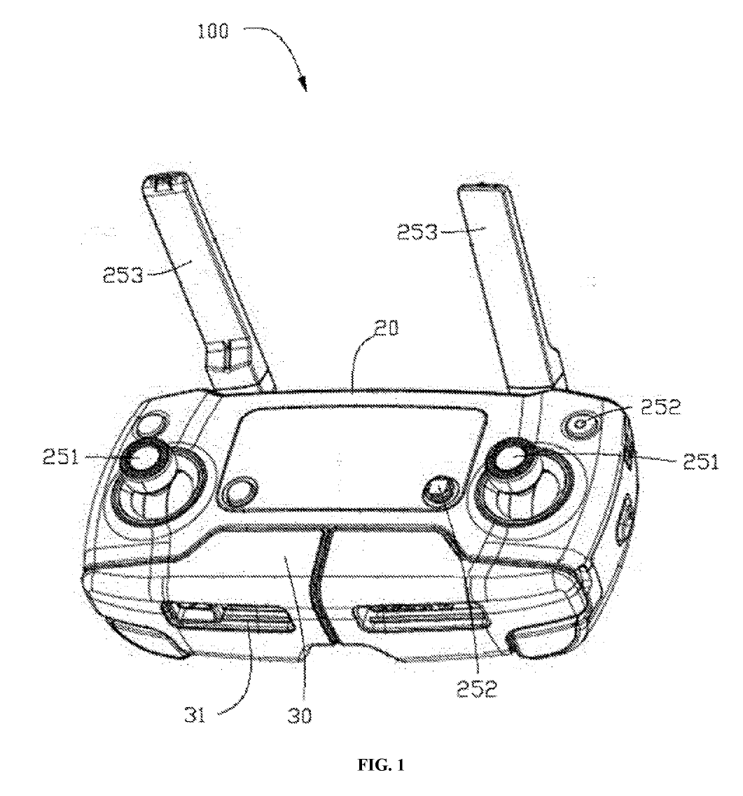

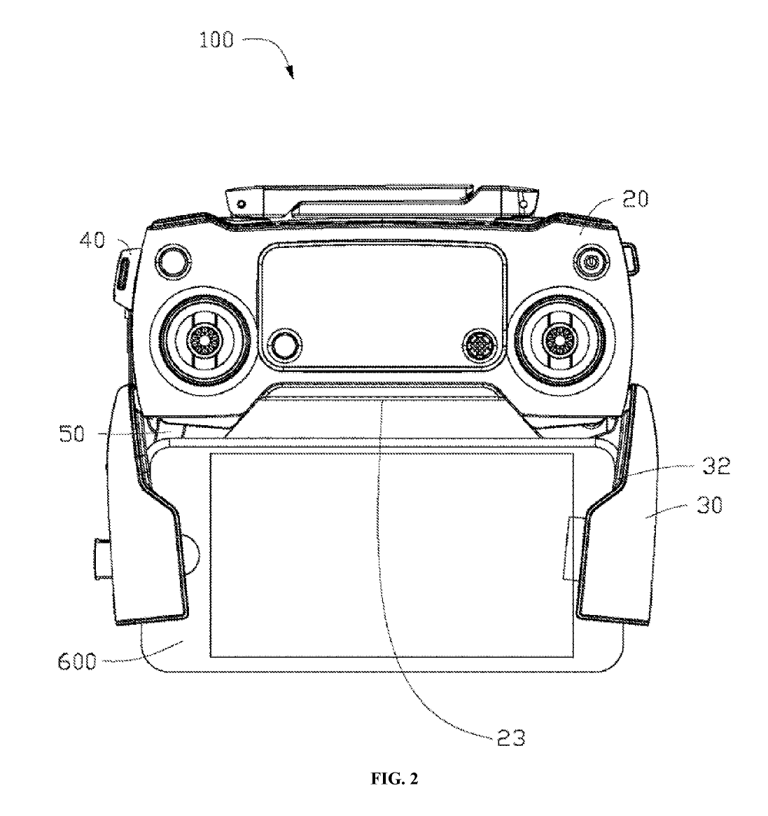

As shown in FIG. 1 and FIG. 2, some embodiments of the present disclosure provide a remote control terminal 100, which includes a remote control main body 20, holding mechanism 30, and a connection cable 40. The holding mechanism 30 is connected to the remote control main body 20 and is configured to hold a mobile terminal 600. The remote control main body 20 can communicate with the mobile terminal 600 through the connection cable 40.

The remote control main body 20 is configured to control a controlled terminal (not shown), receive data returned by the controlled terminal, and transmit the received data to the mobile terminal 600 via the connection cable 40.

Taking an unmanned aerial vehicle (UAV) as the controlled terminal as an example, the remote control main body 20 can control the flight of the UAV and receive image data acquired by the UAV while performing aerial photography. The image data can then be transmitted by the remote control main body 20 to the mobile terminal 600 for previewing and sharing to the Internet or with friends.

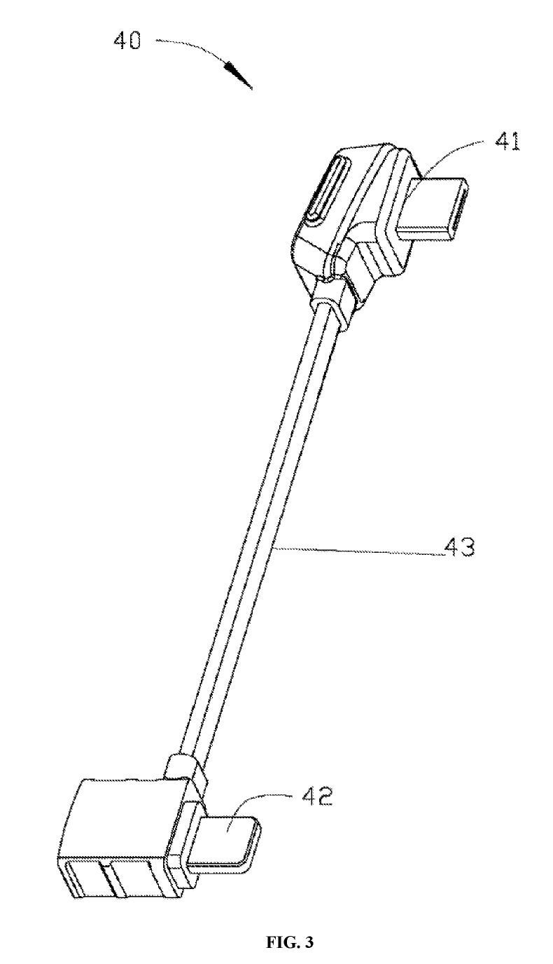

Referring to FIG. 3, in some embodiments, the connection cable 40 includes a first connection terminal 41, a second connection terminal 42, and a connection wire 43 between the first connection terminal 41 and the second connection terminal 42.

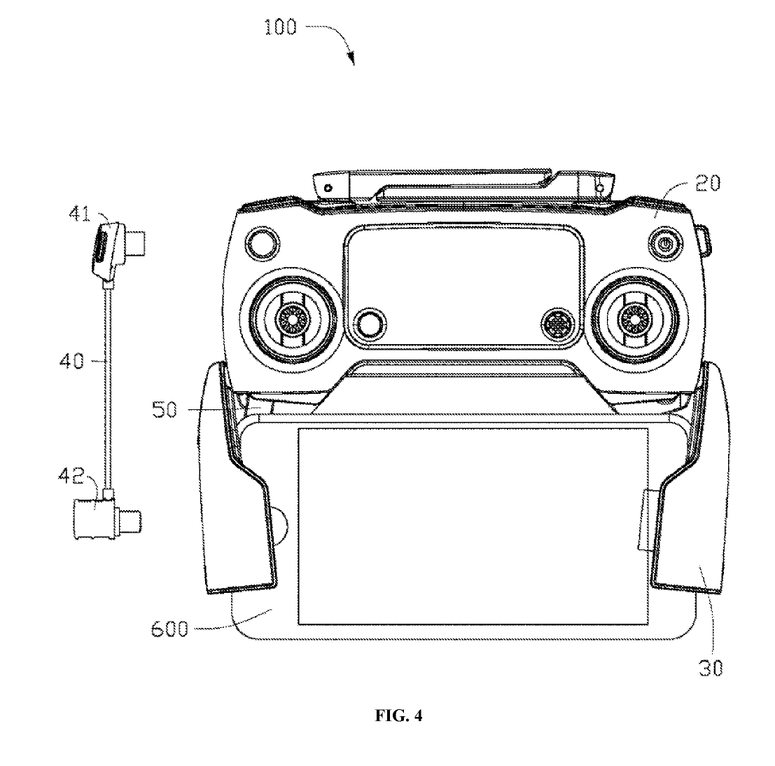

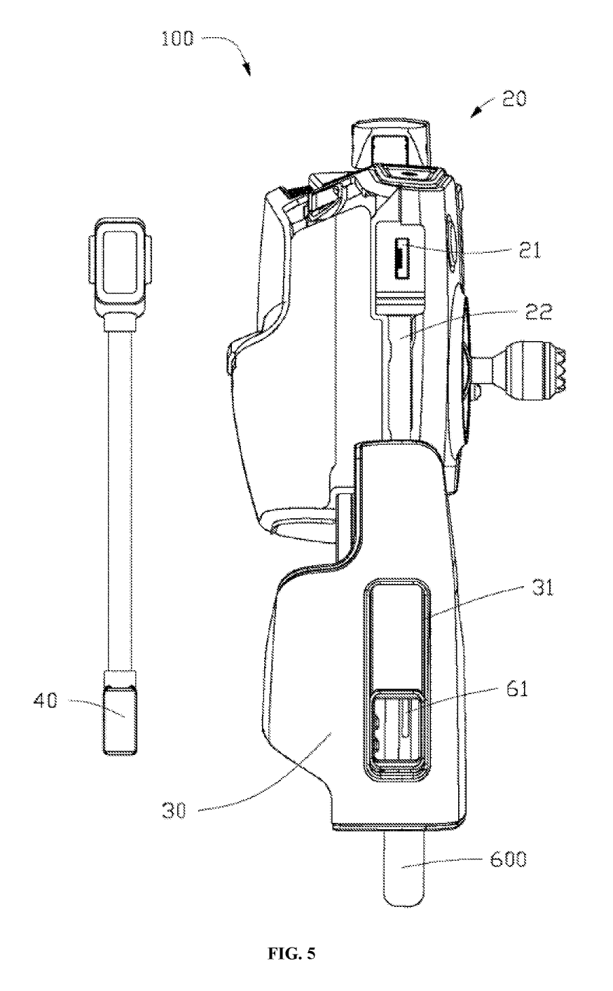

As shown in FIG. 4 and FIG. 5, in some embodiments, the remote control main body 20 includes an electrical connection interface 21 (also referred as a first connection interface) at the side of the remote control main body 20, to match the first connection terminal 41 of the connection cable 40. The second connection terminal 42 of the connection cable 40 is configured to match a mobile terminal interface 61.

In some embodiments, the holding mechanism 30 is movable relative to the remote control main body 20, so that the holding mechanism 30 can be in an extended state to hold the mobile terminal 600 (as shown in FIG. 2), or in a contracted state (as shown in FIG. 1) such that the remote control terminal 100 can be carried easily.

Therefore, when using the remote control terminal 100, a user can move the holding mechanism 30 relative to the remote controller main body 20 so that the holding mechanism 30 is in the extended state. The mobile terminal 600 can be held by the holding mechanism 30, so as to assist remote control, and display and transmit data. After completing the remote control operation or displaying and transmitting data, the user may remove the mobile terminal 600 from the holding mechanism 30 and move the holding mechanism 30 relative to the remote control main body 20 so that the holding mechanism 30 is in the contracted state. When the holding mechanism 30 is in the contracted state, the volume of the remote control terminal 100 is decreased, and the portability of the remote control terminal 100 is improved.

In some embodiments, the holding mechanism 30 includes a positioning mechanism 31 for positioning the second connection terminal 42 of the connection cable 40. When the holding mechanism 30 is in the extended state, the second connection terminal 42 of the connection cable 40 positioned at the positioning mechanism 31 can be connected to an interface 61 of the mobile terminal 600. The interface 61 of the mobile terminal 600 is also referred to as a “mobile terminal interface” 61 (also referred as a second connection interface). When the holding mechanism 30 is in the contracted state, the connection cable 40 can be disposed around a side of the remote controller main body 20.

The two connection terminals of the connection cable 40 are fixed to the remote control main body 20 and the holding mechanism 30, respectively. When the holding mechanism 30 is in the extended state, the connection cable 40 can be used to connect the remote control main body 20 with the mobile terminal 600. When the holding mechanism 30 is in the contracted state, the connection cable 40 can be accommodated.

Referring to FIG. 3, in some embodiments, an extending direction of the first connection terminal 41 and/or an extending direction of the second connection terminal 42 of the connection cable 40 is approximately perpendicular to the connection wire 43 of the connection cable 40. This design may prevent the connection wire 43 from folding and improve the stability of holding the remote control terminal 100 by hand during plugging and unplugging of the first connection terminal 41 and/or the second connection terminal 42.

In some embodiments, the first connection terminal 41 and the second connection terminal 42 may be located at a same side of the connection wire 43.

The electrical connection interface 21 may be a DC socket, a standard socket, a mini USB socket, or a micro-USB socket. The first connection terminal 41 may be a plug corresponding to the type of the electrical connection interface 21, i.e., a DC plug, a standard plug, a Mini USB plug, or a micro-USB plug.

The mobile terminal interface 61 may be a DC socket, a standard socket, a mini USB socket, or a micro-USB socket. The second connection terminal 42 may be a plug corresponding to the type of the electrical connection interface 61, i.e., a DC plug, a standard plug, a Mini USB plug, or a micro-USB plug. The connection cable 40 may be any type of cable corresponding to the type of the mobile terminal interface.

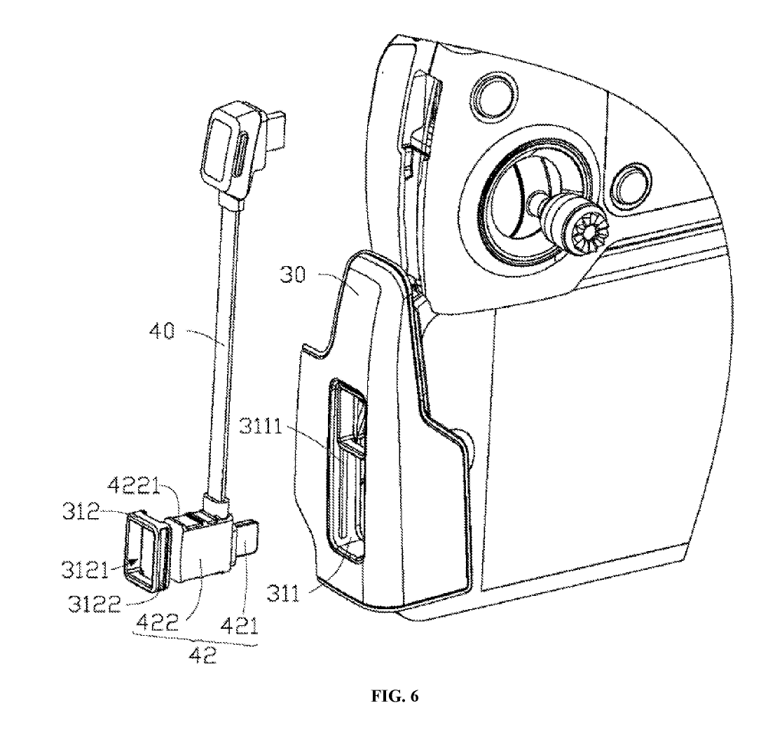

Referring to FIG. 6, in some embodiments, the positioning mechanism 31 includes an accommodating member 311, which has an elongated shape and two opposite ends facing with each other. The second connection terminal 42 of the connection cable 40 can be positioned at any point between the two opposite ends of the accommodating member 311. Therefore, the position of the second connection terminal 42 of the connection cable 40 in the accommodating member 311 can be adjusted, so that the second connection terminal 42 may be able to align with and connect to the mobile terminal interface 61 of different sizes and models.

For example, as shown in FIG. 5, when the holding mechanism 30 is in the extended state, the second connection terminal 42 of the connection cable 40 can be positioned at any position between the opposite ends of the positioning mechanism 31 and electrically connected to the mobile terminal interface 61. As shown in FIG. 1, when the holding mechanism 30 is in the contracted state, the second connection terminal 42 of the connection cable 40 can be positioned at least at one end of the positioning mechanism 31, so that the connection cable 40 is straightened and disposed around the side of the remote controller.

In some embodiments, the second connection terminal 42 of the connection cable 40 may be moved by moving the holding mechanism 30 relative to the remote control main body 20. For example, the holding mechanism 30 can move along the side of the remote control main body 20 to adjust the position of the second connection terminal 42 of the connection cable 40, such that the second connection terminal 42 can be adapted to different types of mobile terminals 600.

Referring to FIG. 6, in some embodiments, the positioning mechanism 31 further includes a sliding frame 312, which is slidably disposed in the accommodating member 311. The sliding frame 312 includes a through hole 3121. The second connection terminal 42 of the connection cable 40 is sleeved in the through hole 3121 and can slide along the sliding frame 312 to be positioned at any position in the accommodating member 311 of the positioning mechanism 31.

Moreover, the accommodating member 311 includes a first mating structure 3111 at an inner wall of the accommodating member 311. The sliding frame 312 includes a second mating structure 3122 at an outer surface of the sliding frame 312 and configured to engage with the first mating structure 3111. Through the engagement between the first mating structure 3111 and the second mating structure 3122, the sliding frame 312 can be slidably locked in the accommodating member 311.

In some embodiments, the first mating structure 3111 may be a guiding groove, and correspondingly the second mating structure 3122 may be a guiding rail. In some embodiments, the first mating structure 3111 may be a guiding rail, and correspondingly the second mating structure 3122 may be a guiding groove.

In some embodiments, the sliding frame 312 is made of a self-lubricating material, which enhances the reliability of sliding of the sliding frame 312.

In some embodiments, the second connection terminal 42 of the connection cable 40 includes a connecting member 421 for cooperating with the mobile terminal interface 61, and a pressing member 422 to be sleeved in the sliding frame 312.

In some embodiments, the pressing member 422 has a flange 4221 at an end distal from the connecting member 421. An outer diameter of the flange 4221 is approximately equal to an inner diameter of the through hole 3121 of the sliding frame 312. Therefore, when the pressing member 422 is inserted into the through hole 3121 of the sliding frame 312 by an external force, the pressing member 422 may not automatically fall off from the sliding frame 312.

Thus, when the connection cable 40 is not in use, the first connection terminal 41 of the connection cable 40 can remain inserted in the electrical connection interface 21 of the remote control main body 20, while the second connection terminal 42 is secured in the accommodating member 311 of the positioning mechanism 31. Such a configuration can effectively solve the problem that the connection cable 40 is relatively independent of the remote control main body 20 and hence easy to be lost or left behind.

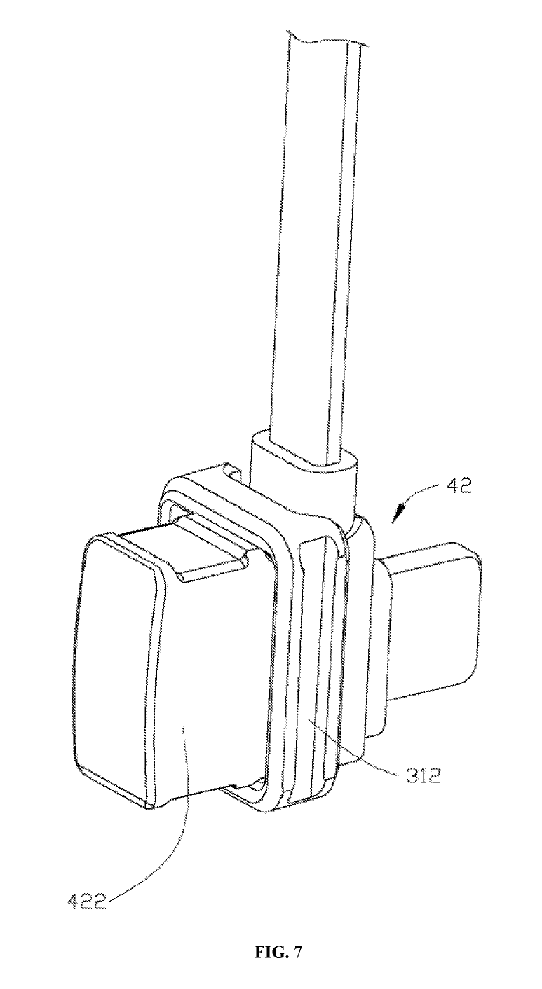

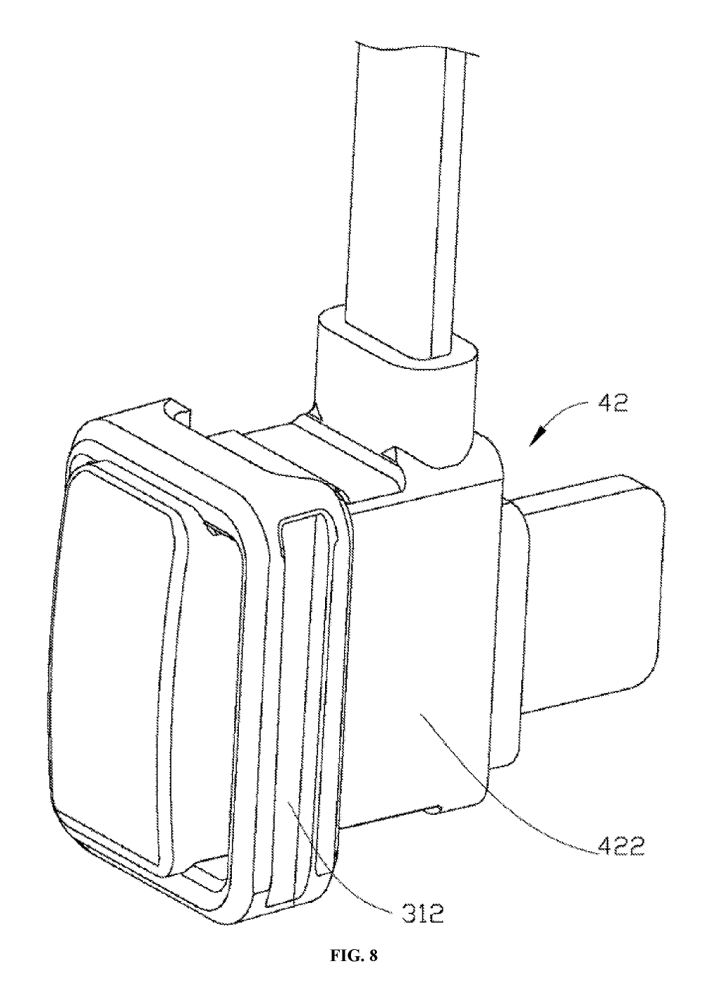

In embodiments, the accommodating member 311 is a through hole. As shown in FIG. 7 and FIG. 8, the second connection terminal 42 of the connection cable 40 is movable in the sliding frame 312. Therefore, the second connection terminal 42 of the connection cable 40 can move in the accommodating member 311 forward to or backward from the mobile terminal 600, e.g., along a direction parallel to an axial direction of the through hole, by a predetermined distance. In some embodiments, the predetermined distance is about 0-6 mm. In this way, the user can easily plug and unplug the second connection terminal 42 of the connection cable 40 while holding the second connection terminal 42 of the connection cable 40. Therefore, the remote control main body 20 can be quickly connected to or disconnected from the mobile terminal 600.

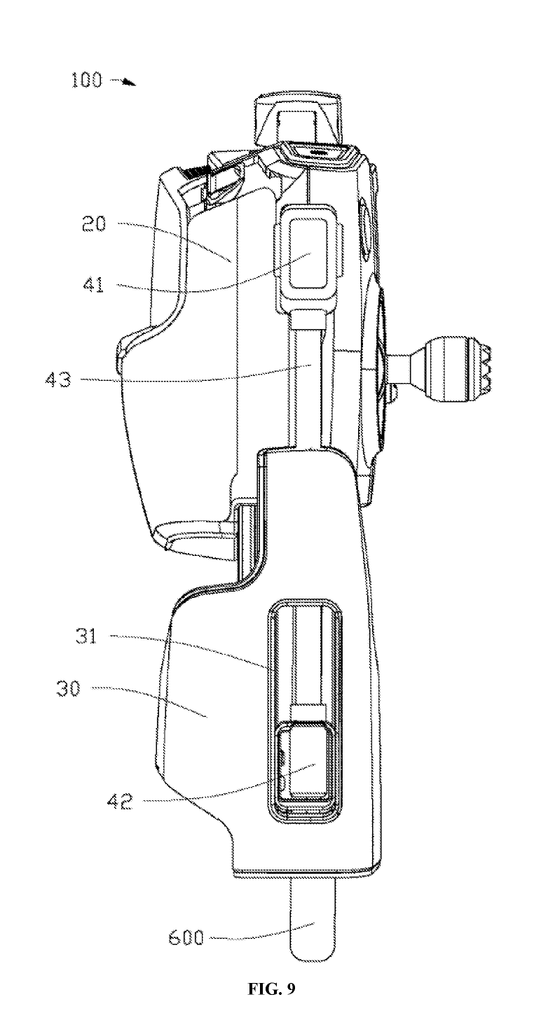

In some embodiments, the pressing member 422 is inserted into the sliding frame 312 from the inside to the outside of the holding mechanism 30. In this way, as shown in FIG. 9, a part of the connection wire 43 of the connecting wire 40 can be hidden inside the holding mechanism 30, so that the connection wire 43 can be partially hidden at the inside of the holding mechanism 30. Problems caused by the exposure of the connection wire 43, such as scattering, scratching, or wearing out of wires, can be effectively solved, and hence the connection cable 40 can be better protected and have an extended lifetime. Meanwhile, the remote control terminal 100 can have a tidy appearance and the user experience can be improved.

Referring again to FIG. 1, in some embodiments, the holding mechanism 30 in the contracted state can match the edge of the remote control main body 20. The remote control main body 20 can include a receiving hole (not shown) at the side facing the holding mechanism 30. When the holding mechanism 30 is in the contracted state, the receiving hole is disposed opposite to the accommodating member 311 of the positioning mechanism 31 and accommodates the second connection terminal 42 of the connection cable 40. As a result, the second connection terminal 42 of the connecting wire 40 can be further fixed and protected.

As shown in FIG. 5, in some embodiments, the side of the remote control main body 20 includes a wire tray 22 at the opening of the first connection interface. The wire tray extends from the first connection interface to a connecting point between the holding mechanism 30 and the remote control main body 20. The wire tray 22 is configured to route the connection wire 43 of the connection cable 40.

In some embodiments, the wire tray 22 can closely match the connection wire 43 of the connection cable 40.

In some embodiments, the connection wire 43 may be attached to the wire tray 22 by a magnetic attraction without protruding from the wire tray 22. In this way, the exposed portion of the connection wire 43 of the connection cable 40 can be tightly fitted in the wire tray 22, which can effectively prevent scratches and damages of the connection cable caused by the connection wire 43 protruding out of the remote control main body 20. Therefore, the connection cable 40 can be better protected and have an extended lifetime. Further, the problem that the connecting wire 40 is scattered on the outside of the remote controller body 20 when the connecting wire 40 is carried or used is effectively solved, so as to keep the appearance of the remote control terminal 100 tidy and improve the user experience.

In some embodiments, one of the inside of the wire try 22 and the connection wire 43 includes a magnetic body, and the other one may include a magnetic body or a metal body that can be attracted by a magnet. For example, a magnetic body is disposed inside the wire try 22 and a metal body is correspondingly disposed at the connection wire 43. As another example, a metal body is disposed inside the wire tray 22 and a magnetic body is correspondingly disposed at the connection wire 43. As a further example, magnetic bodies are disposed at both the inside of the wire try 22 and the connection wire.

In some embodiments, the magnetic body may be a magnet, and the metal body may be a metal that can be attracted by the magnet, such as iron, stainless steel, etc.

Referring again to FIG. 1 and FIG. 2, the remote control main body 20 includes a front surface and multiple sides connected to the front surface. One of the multiple sides is a lower side of the remote control main body 20, and the lower side is close to the user when the remote control main body 20 is in use.

The holding mechanism 30 can hold the mobile terminal 600 near the lower side of the remote control main body 20. The lower side is close to the user when the remote control main body 20 is in use, and the holding mechanism 30 can hold the mobile terminal 600 near the lower side. Therefore, the mobile terminal 600 is close to the user when the remote control main body 20 is in use, which facilitates the user to operate the mobile terminal 600 and view the data displayed by the mobile terminal 600. Further, the lower side of the remote control main body 20 can also support the mobile terminal 600, thereby improving the stability of the mobile terminal 600. In some embodiments, the holding mechanism 30 in the extended state can hold the mobile terminal 600 above or below the front surface of the remote control main body 20.

In some embodiments, the holding mechanism 30 in the contracted state abuts against the lower side of the remote control main body 20. That is, the holding mechanism 30 in the contracted state can be in contact with the lower side surface, further reducing the space occupied by the remote control terminal 100 and improving its portability. Further, the lower side of the remote control main body 20 can also support the holding mechanism 30, improving the stability of the holding mechanism 30 in the contracted state. The holding mechanism 30 in the contracted state may also abut against the front surface or another side of the remote controller body 20.

In some embodiments, the remote control main body 20 further includes other structures, such as operation devices 251 and function buttons 252 for the user to input remote control commands, antennas 253, etc. The operating devices 251 and the function buttons 252, etc., may be disposed on the front surface of the remote control main body 20. Therefore, the user can easily operate the operation devices 251 and/or the function buttons 252, etc.

The antennas 253 are rotatably connected to the remote control main body 20. The antennas 253 are rotatable with respect to the remote control main body 20 so that the antennas 253 can be stretched to an in-use state or folded to an accommodated state. When the antennas 253 are folded and in the accommodated state, the space occupied by the remote control terminal 100 is reduced, and the portability of the remote control terminal 100 is improved.

Referring to FIG. 2, in some embodiments, a receiving member 23 is also disposed at a side of the remote control main body 20 facing the holding mechanism 30. When the holding mechanism 30 is in the contracted state, at least part of the holding mechanism 30 is in the receiving member 23. The holding mechanism 30 in extended state protrudes out of the receiving member 23. Since the holding mechanism 30 in the contracted state is at least partially located in the receiving member 23, the volume of the remote control terminal 100 can be further reduced, and portability of the remote control terminal 100 can be improved.

In some embodiments, the remote control terminal 100 also includes a connection mechanism 50 connected between the remote control main body 20 and the holding mechanism 30. The holding mechanism 30 is movably connected with the remote control main body 50 through the connection mechanism 50.

In some embodiments, for example, the holding mechanism 30 may be rotatably connected to the remote control main body 20 through the connection mechanism 50. For example, as shown in FIG. 2, the control terminal 100 includes two holding mechanisms 30, which are rotatably connected to the remote control main body 20 through the connection mechanisms 50. In the extended state, the two holding mechanisms 30 are spaced apart from each other, forming a space between the two holding mechanisms for holding the mobile terminal 600.

Each of the two holding mechanisms 30 includes a clamping member 32. When the two holding mechanisms 30 are in the extended state, the clamping members 32 can hold the mobile terminal 600 by clamping two ends of the mobile terminal 600. Therefore, the holding of the two holding mechanisms 30 to the mobile terminal 600 is more reliable.

An anti-skid element (not shown) may be disposed at each of the clamping members 32 to contact with the mobile terminal 600. The anti-skid element may prevent the mobile terminal 600 from falling off by applying resistance to the mobile terminal 600.

In some embodiments, each of the connection mechanisms 50 includes a rotation rod (not shown), one end of the rotation rod is rotatably connected with the remote control main body 20, and the other end is rotatably connected with each of the two holding mechanisms 30. By rotating the rotation rod relative to the remote controller body 20 and rotating the two holding mechanisms 30 relative to the rotation rod, the two holding mechanisms 30 can be extended or contracted, which is a simple and reliable operation.

In some embodiments, one end of the rotation rod may include a first rotation shaft (not shown), and the other end of the rotation rod may include a second rotation shaft (not shown). The rotation rod is rotatably connected with the remote controller body 20 through the first rotation shaft, and the rotation rod is rotatably connected with each of the two holding mechanisms 30 through the second rotation shaft. By rotating the rotation rod about the first rotation shaft relative to the remote control main body 20 and rotating each of the two holding mechanisms 30 about the second rotation shaft with respect to the rotation rod, the two holding mechanisms 30 can be extended or contracted. Thereby, the connection mechanism 50 is simple in structure and reliable in use.

In some embodiments, the first shaft and/or the second shaft may be a damping shaft to facilitate the positioning between the rotating rod and the remote control main body 20 or the two holding mechanisms 30, and the positioning between the two holding mechanisms 30 and the remote control main body 20. Positioning between the rotating rod, the remote control main body 20, and the two holding mechanisms 30 can also be achieved by other additional positioning devices.

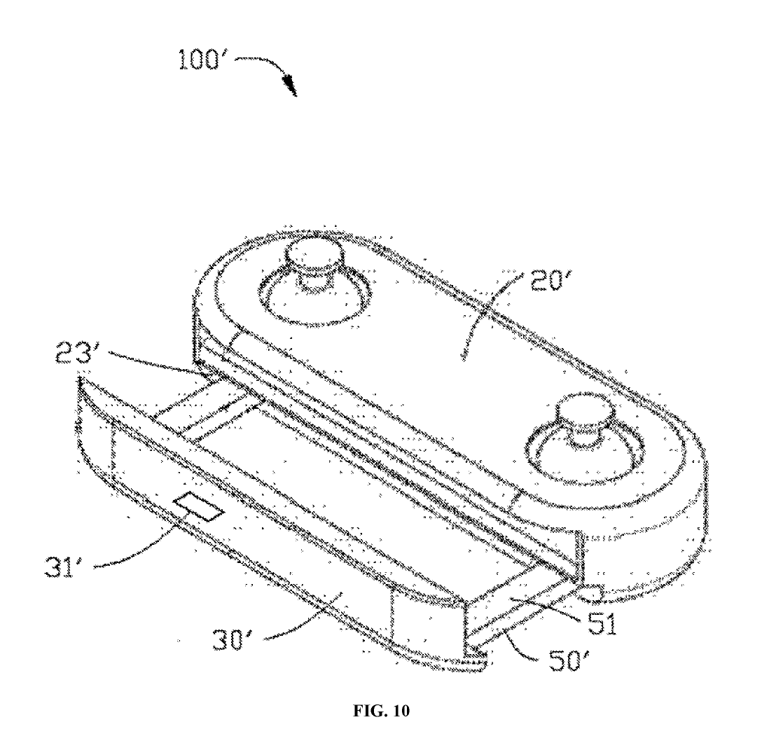

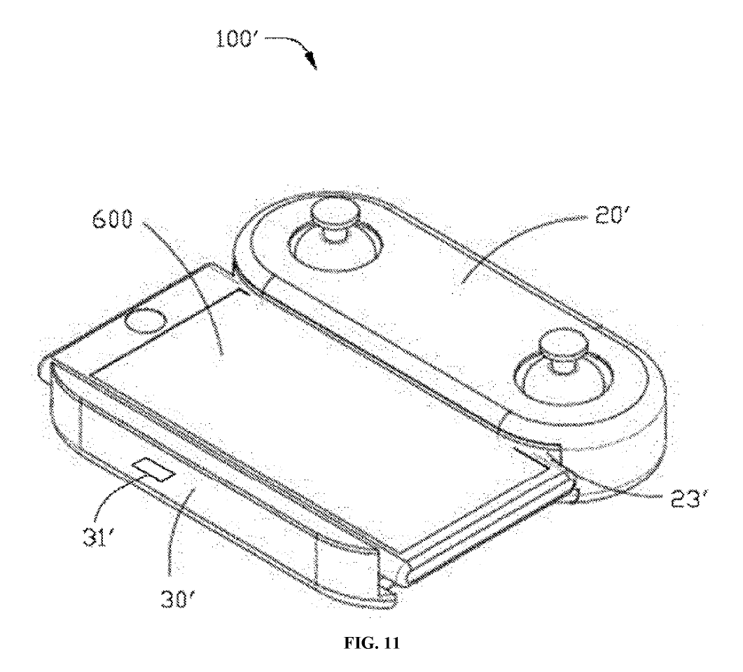

FIG. 10 and FIG. 11 show another remote control terminal 100′ according to some embodiments of the present disclosure. The remote control terminal 100′ includes a holding mechanism 30′ slidably connected with a remote control main body 20′ through a connection mechanism 50′. The connection mechanism 50′ is disposed in a receiving member 23′, and does not occupy an external space of the remote controller body 20′. This further reduces the volume of the remote control terminal 100′. Therefore, the portability and overall appearance of the remote control terminal 100′ are improved. The connection mechanism 50′ may also be disposed outside the receiving member 23′.

In some embodiments, the connecting mechanism 50′ includes a sliding member 51. The connecting mechanism 50′ is fixedly connected with the holding mechanism 30′ and is slidably connected with the remote control main body 20 through the sliding member 51. The sliding member 51 may be able to slidably move inside the receiving member 23′, so that the holding mechanism 30′ may move close to or away from the remote control main body 20′. Therefore, through the relative sliding between the sliding member 51 and the remote control main body 20, the holding mechanism 30′ can slide relative to the remote control main body 20, thereby improving the reliability of the sliding of the holding mechanism 30′.

In some embodiments, the receiving member 23′ may include a guiding member (not shown) to engage with the sliding member 51. With the collaboration between the sliding member 51 and the guiding member, the connection mechanism 50′ can drive the holding mechanism 30′ to slide along a predetermined direction. Thereby, the sliding of the holding mechanism 30′ can be more reliable.

In some embodiments, the guiding member may be a guiding groove, and the sliding member 51 may be correspondingly configured as a guiding rail. In some other embodiments, the guiding member may be a guiding rail, while the sliding member 51 may be a guiding groove. Therefore, the sliding member 51 and the guiding member can be simple in structure and reliable in use.

In some embodiments, the holding mechanism 30′ in the extended state is relatively spaced apart from the remote control main body 20′, forming a space between the holding mechanism 30′ and the remote control main body 20′ for holding the mobile terminal 600.

In some embodiments, the holding mechanism 30′ includes a clamping member (not shown). When the holding mechanism 30′ is in the extended state, the clamping member can hold the mobile terminal 600 between the remote control main body 20′ and the holding mechanism 30′ by clamping one end of the mobile terminal 600. Therefore, the holding of the holding mechanism 30 to the mobile terminal 600 is more reliable.

In some embodiments, an anti-skid element (not shown) may be disposed at the clamping member 32 to contact with the mobile terminal 600. The anti-skid element may prevent the mobile terminal 600 from falling off by applying resistance to the mobile terminal 600.

It is intended that the specification and embodiments be considered as examples only and not to limit the scope of the disclosure. Any modification and equivalently replacement for the technical solution of the present disclosure should all fall in the spirit and scope of the technical solution of the present disclosure.

What is claimed is:

1. A remote control terminal comprising:
a connection cable including a first connection terminal, a second connection terminal and a connection wire between the first connection terminal and the second connection terminal;
a remote control main body including an electrical connection interface at a side of the remote control main body and configured to be coupled to the first connection terminal; and
a holding mechanism connected to the remote control main body and configured to move relative to the remote control main body to switch between an extended state and a contracted state, the holding mechanism including a positioning mechanism configured to position the second connection terminal.

2. The remote control terminal according to claim 1, wherein:
the positioning mechanism includes an accommodating member having an elongated shape and two opposite ends; and
the second connection terminal of the connection cable is configured to be positioned at any point between the two opposite ends of the accommodating member.

3. The remote control terminal according to claim 2, wherein:
the positioning mechanism further includes a sliding frame slidably disposed in the accommodating member and including a through hole; and
the second connection terminal of the connection cable is configured to be sleeved in the through hole and to slide with the sliding frame to be positioned at any position in the accommodating member of the positioning mechanism.

4. The remote control terminal according to claim 3, wherein:
the accommodating member includes a first mating structure at an inner wall of the accommodating member;
the sliding frame includes a second mating structure at an outer surface of the sliding frame and configured to engage with the first mating structure;
the sliding frame is slidably locked in the accommodating member through an engagement between the first mating structure and the second mating structure.

5. The remote control terminal according to claim 4, wherein:
one of the first mating structure and the second mating structure is a guiding groove, and another of the first mating structure and the second mating structure is a guiding rail.

6. The remoter control terminal according to claim 3, wherein:
the sliding frame includes a self-lubricating material.

7. The remote control terminal according to claim 3, wherein the second connection terminal of the connection cable includes:
a connecting member configured to be coupled to an interface of a mobile terminal; and
a pressing member configured to be sleeved in the sliding frame.

8. The remote control terminal according to claim 7, wherein:
the pressing member includes a flange at an end distal from the connecting member, and an outer diameter of the flange is approximately equal to an inner diameter of the through hole of the sliding frame.

9. The remote control terminal according to claim 8, wherein:
the pressing member is configured to be inserted into the sliding frame from an inside to an outside of the holding mechanism.

10. The remote control terminal according to claim 2, wherein:
the accommodating member includes a through hole; and
the second connection terminal of the connection cable is configured to move in the accommodating member along a direction parallel to an axial direction of the through hole by a predetermined distance.

11. The remote control terminal according to claim 10, wherein the predetermined distance is in a range from 0 to 6 mm.

12. The remote control terminal according to claim 1, wherein:
the remote control main body includes a receiving hole at a side of the remote control main body facing the holding mechanism, the receiving hole being at a location corresponding to the positioning mechanism when the holding mechanism is at the contracted state, and configured to accommodate the second connection terminal of the connection cable when the holding mechanism is at the contracted state.

13. The remote control terminal according to claim 1, wherein:
the remote control main body includes a wire tray at the side of the remote control main body, the wire tray extending from the first connection interface to a connecting point between the holding mechanism and the remote control main body; and
the wire tray is configured to accommodate the connection wire of the connection cable.

14. The remote control terminal according to claim 13, wherein:
one of the connection wire and an inner side of the wire tray is configured with a first magnetic body; and
another one of the connection wire and the inner side of the wire tray is configured with a second magnetic body or a metal body.

15. The remote control terminal according to claim 1, wherein the first connection terminal and the second connection terminal are located at a same side of the connection wire.

16. The remote control terminal according to claim 1, wherein:
the electrical connection interface includes a DC socket, a standard socket, a mini USB socket, or a micro-USB socket; and
the first connection terminal includes a plug corresponding to a type of the electrical connection interface.

17. The remote control terminal according to claim 1, wherein
the second connection terminal includes a DC plug, a standard plug, a mini USB plug, or a micro USB plug.

18. The remote control terminal according to claim 1, further comprising:
a connection mechanism connecting the remote control main body with the holding mechanism;
wherein the holding mechanism is movably connected to the remote control main body through the connection mechanism.

19. The remote control terminal according to claim 18, wherein the holding mechanism in the contracted state matches an edge of the remote control main body.

20. The remote control terminal according to claim 18, wherein:
the remote control main body further includes a receiving member at a side of the remote control main body facing the holding mechanism, the receiving member being configured to receive at least a part of the holding mechanism when the holding mechanism is in the contracted state.
